(19) United States
(12) Patent Application Publication
(10) Pub. No.: US 2026/0135499 A1
(43) Pub. Date: May 14, 2026

(54) MOTOR DRIVING SYSTEM AND METHOD OF CONTROLLING SAME

(71) Applicants: HYUNDAI MOTOR COMPANY, Seoul (KR); KIA CORPORATION, Seoul (KR)

(72) Inventors: Byung Oh Tak, Hwaseong-si (KR); Seung Hyeon Bin, Hwaseong-si (KR); Hee Won An, Hwaseong-si (KR); Joon Ha Hwang, Hwaseong-si (KR); Seong Min Kim, Hwaseong-si (KR); Ho Sun Jang, Hwaseong-si (KR)

(73) Assignees: HYUNDAI MOTOR COMPANY, Seoul (KR); KIA CORPORATION, Seoul (KR)

(21) Appl. No.: 19/229,537

(22) Filed: Jun. 5, 2025

(30) Foreign Application Priority Data
Nov. 13, 2024 (KR) 10-2024-0160658

(51) Int. Cl. H02P 6/08; H02M 7/537; H02P 25/18; H02P 27/06; H02P 29/60

(52) U.S. Cl. CPC H02P 6/08; H02M 7/537; H02P 25/18; H02P 27/06; H02P 29/60

(57) ABSTRACT

A motor driving system is provided. The motor driving system controls a driving mode of a motor such that the system switches to one of a first driving mode and a second driving mode, and when a first target operating point according to a current required output belongs to a second operating point area corresponding to the second driving mode, and a second target operating point according to torque derating of the motor belongs to a first operating point area corresponding to the first driving mode, tracks the second target operating point in the second driving mode.

### CROSS-REFERENCE TO RELATED APPLICATION(S)

This application claims priority from Korean Patent Application No. 10-2024-0160658, filed on Nov. 13, 2024 in the Korean Intellectual Property Office, the disclosure of which is incorporated herein by reference in its entirety.

### TECHNICAL FIELD

The present disclosure relates to a motor driving system with improved driving mode switching logic in a torque derating situation and a method of controlling the same.

### BACKGROUND

Generally, one end of each winding of phases included in a motor is connected to an inverter and the other ends of the windings are connected to form a Y-connection.

When the motor is driven, a switching element in the inverter is turned on/off by pulse width modulation control and applies a line voltage to the Y-connected windings of the motor to generate alternating current, thereby generating torque.

The fuel efficiency (e.g., or power efficiency) of an eco-friendly vehicle such as an electric vehicle that uses the torque generated by a motor as power is determined by the power conversion efficiency of the inverter-motor, and thus it is useful to maximize the power conversion efficiency of the inverter and the efficiency of the motor to improve fuel efficiency.

The efficiency of an inverter-motor system may be (e.g., mainly) determined by a voltage utilization rate of the inverter, and if an operating point of a vehicle, which is determined by the relationship between the motor speed and torque, is formed in a range where the voltage utilization rate is high, the fuel efficiency of the vehicle can be improved.

However, as the number of winding turns of the motor increases in order to increase the maximum torque of the motor, the range with the high voltage utilization rate becomes farther away from a low torque area, which is the main operating point of the vehicle, and thus fuel efficiency may decrease. In addition, if the main operating point is designed to be included in the range with the high voltage utilization rate from the perspective of fuel efficiency, there is a limitation on the maximum torque of the motor, which may decrease the acceleration and starting performance of the vehicle.

As motor driving technology that can improve the efficiency of the system while covering both low-power and high-power ranges with one motor is useful, driving a single motor in two different modes using two inverters and a mode switch recently has been introduced.

The matters described as the background above are intended to increase the understanding of the background of the present disclosure and should not be recognized as prior art.

### SUMMARY

The present disclosure provides a motor driving system and a method of controlling the same that can prevent (e.g., or minimize) damage to an inverter by improving a driving mode switching logic of a motor in a torque derating situation.

The present disclosure is not limited to the objects mentioned herein, and other objects not mentioned may be understood from the description herein.

In an example embodiment, a motor driving system is provided, and the motor driving system includes a motor including a plurality of windings, a first inverter connected to one end (e.g., a first end) of each of the plurality of windings, a second inverter connected to the other end (e.g., a second end) of each of the plurality of windings, and a controller configured to control a driving mode of the motor to switch to one of a first driving mode in which the motor is driven using the first inverter and a second driving mode in which the motor is driven using the first inverter and the second inverter. When a first target operating point based on (e.g., according to) a current (e.g., required) output belongs to a second operating point area corresponding to the second driving mode and a second target operating point according to torque derating of the motor belongs to a first operating point area corresponding to the first driving mode, track the second target operating point in the second driving mode.

In an example embodiment, there is provided a method of controlling a motor driving system. The motor driving system includes a motor having a plurality of windings, a first inverter connected to one end of each of the plurality of windings, and a second inverter connected to the other end of each of the plurality of windings, the method including controlling a driving mode of the motor to switch to one of a first driving mode in which the motor is driven using the first inverter and a second driving mode in which the motor is driven using the first inverter and the second inverter, and when a first target operating point according to a current (e.g., required) torque belongs to a second operating point area corresponding to the second driving mode and a second target operating point according to torque derating of the motor belongs to a first operating point area corresponding to the first driving mode, tracking the second target operating point in the second driving mode.

### BRIEF DESCRIPTION OF THE DRAWINGS

The objects and features of the present disclosure may be understood from the description herein and the accompanying drawings, in which:

FIG. 1 is a circuit diagram of a motor driving system according to an example embodiment of the present disclosure;

FIG. 2 is a diagram of switching of a motor driving mode according to an example embodiment of the present disclosure;

FIGS. 3, 4, and 5 are diagrams of an operating point tracking method in a torque derating situation according to an example embodiment of the present disclosure; and

FIG. 6 is a flowchart of a method of controlling a motor driving system according to an example embodiment of the present disclosure.

### DETAILED DESCRIPTION

Structural and functional descriptions of the example embodiments of the present disclosure, disclosed herein, are illustrative, and the example embodiments according to the present disclosure may be provided in various forms and should not be construed as being limited to the example embodiments described herein.

Since the example embodiments according to the present disclosure may be modified in various manners and have various forms, example embodiments may be provided in the drawings and described herein. The disclosure and drawings are not intended to limit the example embodiments, and may be understood to include changes, equivalents, and substitutes included in the scope of the present disclosure.

Terms including technical or scientific terms have the same or similar meanings as generally understood in the art to which the present disclosure pertains unless mentioned otherwise. Generally used terms, such as terms defined in a dictionary, may be interpreted to coincide with meanings of the related art from the context.

Herein, example embodiments disclosed here may be described with reference to the figures. Identical or similar components may be assigned the same or similar reference numerals, and redundant descriptions thereof may be omitted.

In the description of the following embodiments, the term “preset” provides that the value of a parameter is predetermined when the parameter is used in a process or an algorithm. Depending on the example embodiments, the value of a parameter may be set when a process or an algorithm starts or may be set during a period in which the process or the algorithm is performed.

The terms “module” and “unit” or “part” may be used to provide components herein to help the understanding of the components and thus they may not be considered as having separate meanings or roles.

In the example embodiments disclosed in the present specification, a detailed description of functions and configurations incorporated herein may be omitted when it may obscure the subject matter of the present disclosure. In addition, the accompanying drawings are provided for understanding of the example embodiments disclosed in the present disclosure, are not intended to limit the technical spirit disclosed herein, and may include (e.g., all) changes, equivalents and substitutes provided in the present disclosure.

The terms “first” and/or “second” are used to describe various components, but such components are not limited by these terms. The terms are used to distinguish one component from another component.

When a component is “coupled” or “connected” to another component, a third component may be present between the two components although the component may be (e.g., directly) coupled or connected to the other component. When a component is “directly coupled” or “directly connected” to another component, no element may be present between the two components.

An element described in the singular form is intended to include a plurality of elements unless the context indicates otherwise.

In the present disclosure, the term “comprise” or “include” may provide the presence of a stated feature, figure, step, operation, component, part or combination thereof, but may not preclude the presence or addition of one or more other features, figures, steps, operations, components, or combinations thereof.

In addition, a unit or a control unit included in names of a component such as a motor control unit (MCU) and a hybrid control unit (HCU) is a term used for a control device that controls (e.g., specific) vehicle functions and may not provide a generic functional unit.

A controller may include a communication device that communicates with other controllers or sensors to control the functions of the controller, a memory that stores an operating system, logic instructions, input/output information, and the like, and one or more processors that perform determination, computation, and decisions to control the functions.

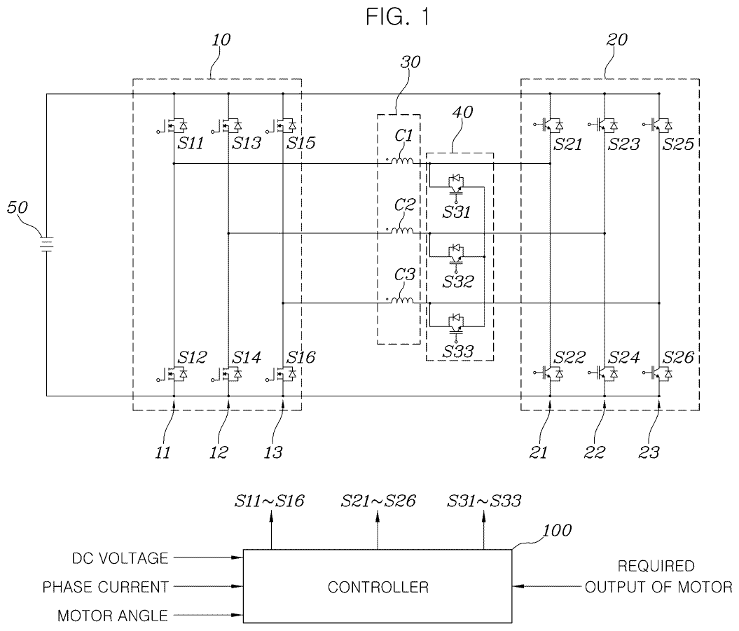

FIG. 1 is a circuit diagram of a motor driving system according to an example embodiment of the present disclosure.

Referring to FIG. 1, the motor driving system according to an example embodiment may include a first inverter 10, a second inverter 20, a motor 30 having a plurality of windings C1, C2, and C3 corresponding to a plurality of phases, a mode switching unit 40, a battery 50, a DC capacitor (e.g., DC-link capacitor) 60, and a controller 70.

The first inverter 10 may include a plurality of first switching elements S11 to S16 connected to one end of each of the plurality of windings C1, C2, and C3, and the second inverter 20 may include a plurality of second switching elements S21 to S26 connected to the other end of each of the plurality of windings C1, C2, and C3. The mode switching unit 40 may include a plurality of switches S31, S32, and S33 connected between the other ends of the plurality of windings C1, C2, and C3 and the neutral terminals of the plurality of windings C1, C2, and C3. The controller 70 may control on/off states of the first switching elements S11, S12, S13, S14, S15, and S16, the second switching elements S21, S22, S23, S24, S25, and S26, and the switches S31, S32, and S33 based on (e.g., required) output power of the motor (e.g., torque command for the motor), a DC link voltage of the inverters 10 and 20 (e.g., the voltage of the battery), the phase current of the motor, and the motor angle.

The first inverter 10 may include a plurality of legs 11, 12, and 13 to which a DC voltage generated in the DC capacitor 60 connected between both ends of the battery 50 is applied. The legs 11, 12, and 13 may be electrically connected to the plurality of phases of the motor 30.

In an example embodiment, the first leg 11 includes two switching elements S11 and S12 connected in series between both ends of the DC capacitor 60, and the connection node of the two switching elements S11 and S12 may be connected to one end of the winding C1 of one phase in the motor 30 such that AC power corresponding to one of the plurality of phases is input and output. Similarly, in an example embodiment, the second leg 12 includes two switching elements S13 and S14 that are connected in series between both ends of the DC capacitor 60, and the connection node of the two switching elements S13 and S14 may be connected to one end of the winding C2 of one phase in the motor 30 such that AC power corresponding to one of the plurality of phases is input and output. In addition, in an example embodiment, the third leg 13 includes two switching elements S15 and S16 that are connected in series between both ends of the DC capacitor 60, and the connection node of the two switching elements S15 and S16 may be connected to one end of the winding C3 of one phase in the motor 30 such that AC power corresponding to one of the plurality of phases is input and output.

The second inverter 20 may include a plurality of legs 21, 22, and 23 to which a DC voltage generated in the DC capacitor 60 connected between both ends of the battery 50 is applied. The legs 21, 22, and 23 may be electrically connected to the plurality of phases of the motor 30.

In an example embodiment, the first leg 21 includes two switching elements S21 and S22 connected in series between both ends of the DC capacitor 60, and the connection node of the two switching elements S21 and S22 may be connected to the other end of the winding C1 of one phase in the motor 30 such that AC power corresponding to one of the plurality of phases is input and output. Similarly, in an example embodiment, the second leg 22 includes two switching elements S23 and S24 connected in series between both ends of the DC capacitor 60, and the connection node of the two switching elements S23 and S24 may be connected to the other end of the winding C2 of one phase in the motor 30 such that AC power corresponding to one of the plurality of phases can be input and output. In addition, in an example embodiment, the third leg 23 includes two switching elements S25 and S26 connected in series between both ends of the DC capacitor 60, and the connection node of the two switching elements S25 and S26 may be connected to the other end of the winding C3 of one phase in the motor 30 such that AC power corresponding to one of the plurality of phases can be input and output.

Each of the plurality of switches S31, S32, and S33 may be connected to the other end of each of the plurality of windings C1, C2, and C3 included in the motor 30, and the other ends of the switches S31, S32, and S33 may be interconnected to form a node. The plurality of switches S31, S32, and S33 may employ other suitable switches or switching means, such as a MOSFET, an IGBT, a thyristor, a relay, and the like.

Although not shown in FIG. 1, the motor driving system may further include a so-called Y-capacitor (Y-Cap) that connects two capacitors connected in series between a positive (+) DC terminal and a negative (−) DC terminal and grounds the connection node between the capacitors.

The controller 70 may control operation of the motor 30 by switching the switching elements S11, S12, S13, S14, S15, S16, S21, S22, S23, S24, S25, and S26 included in the first inverter 10 and the second inverter 20 through pulse width modulation control based on the (e.g., required) output power of the motor 30.

In addition, the controller 70 may control on/off states of the switches S31, S32, and S33 included in the mode switching unit 40 according to a motor driving mode. The motor driving mode may include a first driving mode and a second driving mode. In an example embodiment, the first driving mode may be referred to as a “closed end winding (CEW) mode” and the second driving mode may be referred to as an “open end winding (OEW) Mode”.

In an example embodiment,, the controller 70 may control the switches S31, S32, and S33 to be turned on and drive the motor 30 through the first inverter 10 between the two inverters 10 and 20 in the CEW mode. The mode switches S31, S32, and S33 may form a neutral point of the motor through the node to which the other ends thereof are connected in the on state.

In an example embodiment,, the controller 70 may control the switches S31, S32, and S33 to be turned off and drive the motor 30 through the two inverters 10 and 20 in the OEW mode. The switches S31, S32, and S33 may electrically separate the node to which the other ends thereof are connected from the other ends of the plurality of windings C1 to C3 in the OFF state, and in this case, the node to which the other ends of the switches S31, S32, and S33 are connected may not form the neutral point of the motor.

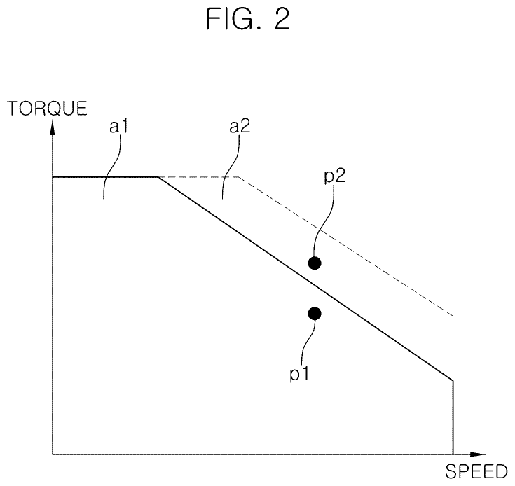

Herein, driving mode switching of the motor according to an example embodiment will be described with reference to FIG. 2.

FIG. 2 is a diagram of switching of the motor driving mode according to an example embodiment of the present disclosure.

Referring to FIG. 2, a first operating point area a1 and a second operating point area a2 are provided in the graph of torque and speed.

The first operating point area a1 is an operating point area of the first driving mode, and when the current target operating point of the motor 30 belongs to the first operating point area a1 (p1), the controller 70 may perform control such that the driving mode of the motor 30 switches to the first driving mode.

The second operating point area a2 is an operating point area corresponding to the second driving mode, and when the current target operating point of the motor 30 belongs to the second driving point area a2 (p2), the controller 70 may perform control such that the driving mode of the motor 30 switches to the second driving mode.

The second operating point area a2 is an area having a torque greater than that of the first operating point area a1 given equal rotation speeds of the motor 30, and accordingly, the output power of the motor 30 may be increased in the second driving mode compared to the first driving mode.

The controller 70 may switch between the first driving mode and the second driving mode in both directions, the motor 30 can be (e.g., efficiently) driven in the first driving mode in a situation where high output power of the motor 30 may not be (e.g., is) not required, and the output power of the motor 30 can be provided (e.g., guaranteed) in the second driving mode in a situation where high output power of the motor 30 may be (e.g., is) required.

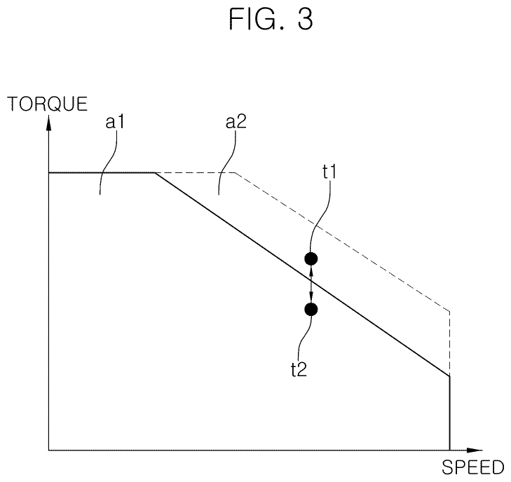

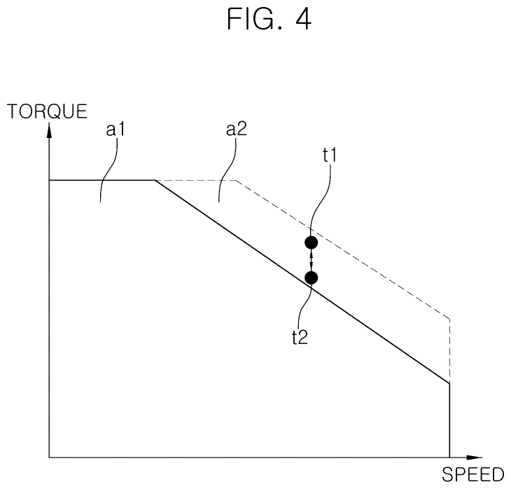

In a situation where the torque of the motor 30 is derated, it is useful (e.g., necessary) to include (e.g., reflect) torque fluctuation due to derating in the driving mode switching logic. In an example embodiment, torque derating may be the control of (e.g., intentionally) limiting or reducing torque, and the controller 70 may perform torque derating when the temperature of at least one of the first inverter 10 and the second inverter 20 meets (e.g., satisfies) a preset temperature condition. For example, torque derating may be performed when the temperature of at least one of the first inverter 10 and the second inverter 20 exceeds a preset temperature and is (e.g., becomes) an overtemperature state. Herein, driving mode switching in a torque derating situation will be provided with reference to FIG. 3 and FIG. 4.

FIGS. 3, 4, and 5 are diagrams of an operating point tracking method in a torque derating situation according to an example embodiment of the present disclosure.

First, referring to FIG. 3, when a first target operating point t1 according to the current (e.g., required) output belongs to the second operating point area a2 corresponding to the second driving mode, and a second target operating point t2 according to torque derating of the motor 30 belongs to the first operating point area a1 corresponding to the first driving mode in a torque derating situation, the controller 70 may track the second target operating point t2 in the second driving mode.

In comparison to FIG. 2, in FIG. 3 in a torque derating situation, the controller 70 performs control such that the driving mode switches to the second driving mode and tracks the second target operating point t2 in the second driving mode even though the second target operating point t2, which is the current target operating point, belongs to the first area a1.

In an example embodiment, when torque derating is released due to torque derating release conditions, such as overtemperature relief of the inverters 10 and 20, being satisfied after the target operating point changes due to torque derating, the target operating point is restored from the second target operating point t2 back to the (e.g., original) target operating point, the first target operating point t1. In an example embodiment in which the driving mode has switched to the first driving mode due to derating based on the operating point area to which the current target operating point belongs, if derating is released, the first target operating point t1 included in the second operating point area a2 is (e.g., temporarily) tracked in the first driving mode until the driving mode is switched again may occur. In this case, a current exceeding the specifications of the switches S31 to S33 may be applied to the inverters 10 and 20, which may cause damage.

Therefore, in an example embodiment, when the first target operating point t1 belongs to the second operating point area a2, the controller 70 tracks the first target operating point t1 in the second driving mode, and when the target operating point changes to the second target operating point t2 due to torque derating and belongs to the first operating point area a1, the controller 70 tracks the second target operating point t2 while maintaining the second driving mode without switching the driving mode to the first driving mode. Accordingly, it may be possible to prevent a situation in which an operating point included in the second operating point area a2 is tracked in the first driving mode as described herein.

Referring to FIG. 4, when both the first target operating point t1 and the second target operating point t2 belong to the second operating point area a2, the controller 70 may track the second target operating point t2 in the second driving mode.

In an example embodiment, if both the target operating points before and after torque derating belong to the second operating point area a2, the driving mode may be controlled depending on the operating point area to which the current target operating point belongs, as described in FIG. 2.

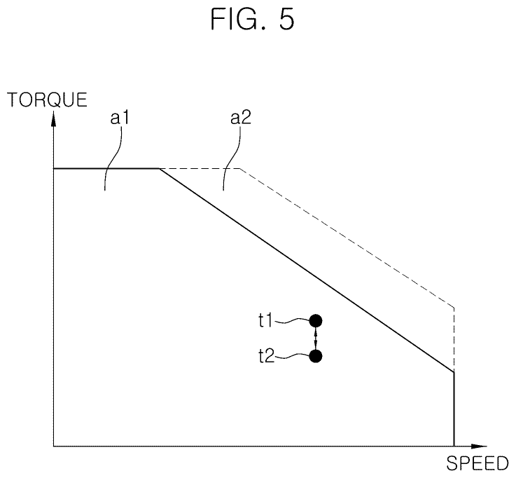

Similarly, referring to FIG. 5, when both the first target operating point t1 and the second target operating point t2 belong to the first operating point area a1, the second target operating point t2 may be tracked in the first driving mode.

In an example embodiment, when both target operating points before and after torque derating belong to the first operating point area a1, the driving mode may be controlled based on the operating point area to which the current target operating point belongs, as described in FIG. 2.

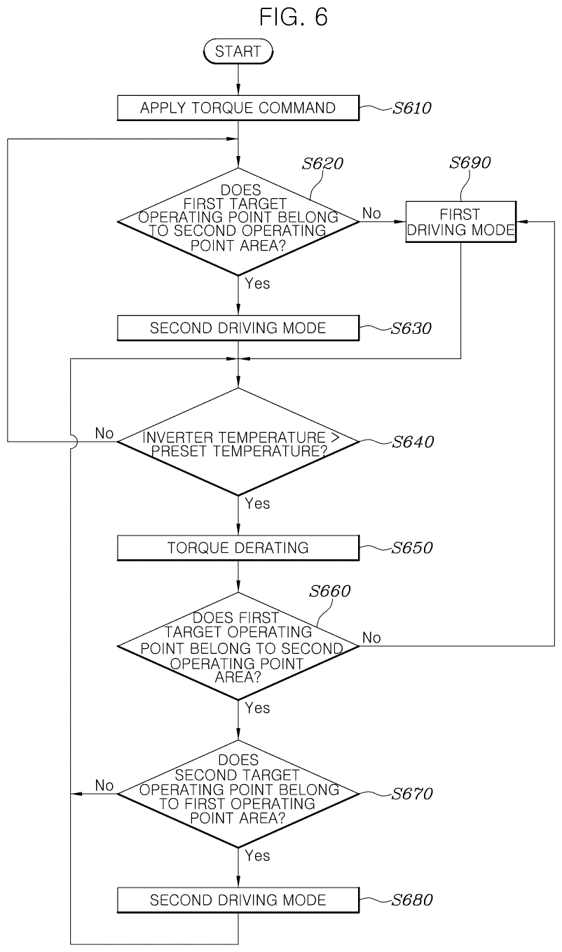

A method of controlling the motor driving system according to an example embodiment will be described with reference to FIG. 6.

Referring to FIG. 6, first, a torque command according to a (e.g., required) output power of the motor 30 is applied to the controller 70 (S610), and the controller 70 determines an operating point area to which the first target operating point according to the torque command belongs (S620).

If the first target operating point belongs to the second operating point area (S620), the controller 70 performs control such that the driving mode of the motor 30 switches to the second driving mode (S630).

Meanwhile, when the temperature of the inverters 10 and 20 exceeds a preset temperature during the operation of the motor 30, the controller 70 changes the first target operating point to the second target operating point through torque derating (S650).

In this case, if the first target operating point belongs to the second operating point area (Yes in S660) and the second target operating point belongs to the first operating point area (Yes in S670), the controller 70 may (e.g., forcibly) maintain the second operating mode without switching the driving mode, and may track the second target operating point (S680).

When the first target operating point belongs to the first operating point area (Yes in S620 and Yes in S660), the driving mode is controlled to switch to the first operating mode (S680).

According to various example embodiments of the present disclosure as described herein, it may be possible to prevent or minimize an operating point of a motor from deviating from an operating point range of the current driving mode during torque derating and a process of releasing the torque derating by improving driving mode switching logic in a torque derating situation, thereby preventing or minimizing damage to an inverter.

The present disclosure is not limited to the effects mentioned herein, and other effects not mentioned may be understood from the disclosure herein.

Although the present disclosure has been provided and described with respect to example embodiments, it may be apparent that the present disclosure can be improved and changed without departing from the present disclosure and claims provided herein.

What is claimed is:

1. A motor driving system including:
a motor including a plurality of windings;
a first inverter connected to a first end of each of the plurality of windings;
a second inverter connected to a second end of each of the plurality of windings; and
a controller configured to control a driving mode of the motor to one of a first driving mode wherein the motor is driven using the first inverter and a second driving mode wherein the motor is driven using the first inverter and the second inverter, and the controller is further configured to track a second target operating point in the second driving mode when a first target operating point according to a current required output belongs to a second operating point area corresponding to the second driving mode and the second target operating point according to torque derating of the motor belongs to a first operating point area corresponding to the first driving mode.

2. The motor driving system of claim 1, wherein the controller performs the torque derating when a temperature of at least one of the first inverter and the second inverter is at or above a preset temperature condition.

3. The motor driving system of claim 1, wherein, when the torque derating is not performed, the controller controls the driving mode to the first driving mode when the first target operating point belongs to the first operating point area.

4. The motor driving system of claim 3, wherein, when the torque derating is not performed, the controller controls the driving mode to the second driving mode when the first target operating point belongs to the second operating point area.

5. The motor driving system of claim 1, wherein the second operating point area includes an area having a torque greater than a torque of the first operating point area given equal rotation speeds of the motor.

6. The motor driving system of claim 1, wherein the controller tracks the second target operating point by the second driving mode when both the first target operating point and the second target operating point belong to the second operating point area.

7. The motor driving system of claim 1, wherein the controller tracks the second target operating point by the first driving mode when both the first target operating point and the second target operating point belong to the first operating point area.

8. The motor driving system of claim 1, further including a plurality of switches, a first end of each of the switches is connected to the second end of each of the plurality of windings.

9. The motor driving system of claim 8, wherein each of the plurality of switches has a second end, wherein the second ends of the switches are interconnected to form a node.

10. The motor driving system of claim 8, wherein the controller controls the driving mode of the motor by turning on or off the plurality of switches.

11. A method of controlling a motor driving system including a motor having a plurality of windings, a first inverter connected to a first end of each of the plurality of windings, and a second inverter connected to a second end of each of the plurality of windings, the method including:
controlling a driving mode of the motor to one of a first driving mode wherein the motor is driven using the first inverter and a second driving mode wherein the motor is driven using the first inverter and the second inverter; and
tracking a second target operating point in the second driving mode, when a first target operating point according to a current required torque belongs to a second operating point area corresponding to the second driving mode and the second target operating point according to torque derating of the motor belongs to a first operating point area corresponding to the first driving mode.

12. The method of claim 11, further including performing the torque derating when a temperature of at least one of the first inverter and the second inverter is at or above a preset temperature condition.

13. The method of claim 11, wherein the controlling a driving mode includes controlling the driving mode to the first driving mode when the first target operating point belongs to the first operating point area.

14. The method of claim 13, further comprising controlling the driving mode to the second driving mode when the first target operating point belongs to the second operating point area when the torque derating is not performed.

15. The method of claim 11, wherein the second operating point area includes an area having a torque greater than a torque of the first operating point area given equal rotation speeds of the motor.

16. The method of claim 11, further including tracking the second target operating point by the second driving mode when both the first target operating point and the second target operating point belong to the second operating point area.

17. The method of claim 11, further including tracking the second target operating point by the first driving mode when both the first target operating point and the second target operating point belong to the first operating point area.

18. The method of claim 11, wherein the motor driving system further includes a plurality of switches, a first end of each of the switches is connected to the second end of each of the plurality of windings.

19. The method of claim 18, wherein each of the plurality of switches has a second end, wherein the second ends of the switches are interconnected to form a node.

20. The method of claim 18, wherein controlling the driving mode of the motor includes turning on or off the plurality of switches.
